(19) United States
(12) Patent Application Publication
(10) Pub. No.: US 2010/0024043 A1
(43) Pub. Date: Jan. 28, 2010

(54) METHOD FOR CONTROLLING ACCESS TO A SCRAMBLED DIGITAL CONTENT

(76) Inventor: Louis Neau, Chateaugiron (FR)

Correspondence Address: Nixon Peabody LLP, P.O. Box 60610, Palo Alto, CA, 94306, US

(21) Appl. No.: 12/519,142

(22) PCT Filed: Dec. 17, 2007
(86) PCT No.: PCT/EP2007/064067

§ 371 Date: Jun. 12, 2009

(30) Foreign Application Priority Data
Dec. 19, 2006 (FR) 06/55632

(51) Int. Cl. H04N 7/16

(52) U.S. Cl. 726/27

(57) ABSTRACT

A method for controlling access by a secret key K to a scrambled digital content distributed, along with the security data D(K) calculated on the basis of K, by an operator equipped with a content server and an access-rights server to at least one receiving terminal comprising a plurality of access-control modules, each access-control module implementing a specific technology for determining the secret key K. The rights server prior to distribution incorporates into said security data D(K) a selection criterion for selecting an access-control module from among the plurality of the terminal's access-control modules to process said security data D(K), after which when one of said access-control modules receives said security data D(K), said access-control module analyses the data D(K) to obtain said selection criterion and, on the basis of its value, terminates processing the data D(K) in order to attempt to obtain the secret key K or transmits a portion or the entirety of said security data D(K) to at least one of the other access-control modules.

### CROSS REFERENCE TO RELATED APPLICATIONS or PRIORITY CLAIM

This application is a national phase of International Application No. PCT/EP2007/064067, entitled “METHOD OF CONTROLLING THE ACCESS TO A SCRAMBLED DIGITAL CONTENT”, which was filed on Dec. 17, 2007, and which claims priority of French Patent Application No. 06 55632, filed Dec. 19, 2006.

### DESCRIPTION

### Technical Field

The invention relates to the field of content protection, particularly to a method for controlling access by a secret key K to a scrambled digital content distributed by an operator to at least one receiving terminal having a plurality of access-control modules, each access-control module implementing a specific technology for determining the secret key K, a method in which the content server transmits the scrambled content to the terminal, and the rights server transmits to the terminal the security data D(K) previously defined according to the secret key K.

The invention also relates to a system for controlling access to a scrambled digital content supplied by an operator to a receiving terminal having a plurality of separate access-control modules, each access-control module implementing a specific technology for determining the secret key K, said system comprising:
a content server having means to scramble the content by means of a secret key K,
a rights server having means to calculate the security data D(K) on the basis of the secret key K.

The invention also relates to a receiving terminal for receiving from an operator a scrambled content by means of a secret key K, said terminal having a plurality of separate access-control modules, each access-control module implementing a specific technology for determining said secret key K, and said terminal furthermore receiving from said operator security data D(K) comprising a selection criterion for selecting one access-control module from among the plurality of the terminal's access-control modules to process said security data D(K).

Finally, the invention relates to a computer program recorded on a data medium and, when run by a computer, intended to implement the method according to the invention.

### The Prior Art

A plurality of separate services such as broadcast television (live TV), video on demand (VOD) or even online purchase services for audiovisual programs, for example, are used by content providers to distribute data and/or multimedia materials to subscribers. The services are deployed across various bearer networks and can be offered in connected or unconnected mode via bidirectional or unidirectional distribution channels.

The modes for arranging and using the contents concerned varies based on the service offered and the bearer network used. These modes are inter alia:
broadcasting for live TV services;
streaming for video-on-demand services (VOD);
downloading for software purchase services;
the (re) reading of content previously received and locally recorded (personal video recorder (PVR)).

The technologies for protecting contents provided to subscribers depends on the type of distribution services used to distribute the contents and on the type of bearer networks used to provide the services.

Typically, the broadcast data streams (or streaming data) as well as the contents recorded in the same formats as the data streams can be protected by conditional-access systems (CAS), and the downloaded files as well as the contents, which were previously obtained by all of the above-mentioned means and recorded in the same format as the files, can be protected by digital rights management (DRM) systems.

The following document provides more information about the proper terminology in the field of CAS systems:
“FUNCTIONAL MODEL OF A CONDITIONAL ACCESS SYSTEM” EBU REVIEW-TECHNICAL EUROPEAN BROADCASTING UNION. BRUSSELS, BE, no 266 21 December 1995.

A detailed presentation of the DRM system (OMA-DRM, for example) can be found in the documents cited by the “Open Mobile Alliance” consortium such as:
“OMA DRM Approved Version 2.0-23” (March 2007) or
“OMA DRM Specification V2.0 Draft Version 2.0-21” (June 2004).

FIG. 1 schematically illustrates a content distribution system in which DRM content protection is used.

The system comprises an operator 1 having a content server 2, said content server being associated with both a module 4 for formatting said contents and with a licences server 6, as well as a receiving device 8 comprising a DRM agent 10, a content reader/decoder 12 and a user interface 13.

In this architecture, the content server 2 receives (arrow 14) from the formatting module 4 a scrambled content in DRM format and transmits (arrow 15) this content to the DRM agent 10.

The licences server 6 receives from the formatting module 4 (arrow 16) information pertaining to the security of the content, such as the key for decrypting (or descrambling) the content, and transmits (arrow 18) the DRM licence associated with the content to the terminal device 8.

Let us recall that a DRM licence corresponds to the juxtaposition of information related to the content, in particular to the identifier of the content and the cryptographic key enabling decryption of the content, and to information about the authorisations for and constraints upon the usage of the content (number of readings, copyrights, expiration date or limited period of use, beneficiary/beneficiaries of the content etc.). The licence represents inter alia the right granted to the terminal licensee to use a content.

FIG. 2 is a schematic representation of a content object 20 and a rights object 22 designating respectively a digital content and the licence associated with that content in the DRM (digital rights management) context.

The content object 20 comprises a content identifier 24 and a document 26 comprising the data (video, audio etc.) that can be decrypted by a key K of which the cryptogram K* 28 is found in the rights object 22. The cryptogram K* is obtained by encryption of the key K by a key Ke that is dependent on the rights transmitter and is securely provided to the terminal for which the content is intended.

The rights object 22 is a collection of data describing the manner in which a digital content can be used. For example, in the case of the “OMA Digital Rights Management” specification established by Open Mobile Alliance, the rights object is described in an XML (Extensible Markup Language) document containing, in particular, rights identifier 30, an attribute 32 (stateful/stateless) clearly indicating whether the rights change during their use, one or more content designations 34 (asset) comprising inter alia content identifier 36 (ContentId) and the cryptogram K* 28 of the key K. The rights object 22 moreover comprises a description 38 of permissions and constraints upon content usage. The level of security of the content or of the resource substantially depends on the level of security of the licence associated with the content, and more precisely to the level of security of the decrypting key K.

The DRM agent 10 in the receiving device 8 assesses the right of the user to access a content on the basis of the description 38 encapsulated in the DRM licence. When the DRM agent 10 provides an authorisation, the content reader 12 permits access to the protected content and descrambles it.

FIG. 3 schematically illustrates a classic architecture of a system for distributing protected content by a conditional access system (CAS).

Identical references designate elements serving the same purpose in the systems shown in FIGS. 2 and 3.

The system illustrated by FIG. 3 comprises a module 40 that formats said contents and is associated with a module 42 that manages conditional access. The user's receiving device 8 comprises in this instance a conditional-access module 44 and a security processor 46. The security processor is, inter alia, intended to process security data relative to the conditional access system, particularly ECM and EMM access-control messages that are introduced below. The processor can be external to or integral with the terminal and can be either hardware, such as a smart card, or software.

In this architecture, the module 42 generates ECM (entitlement control messages) messages that contain the conditions for accessing a content and the key for descrambling the content, which is typically called a control word (CW), and also transmits the messages (arrow 48) to module 40 for formatting. This module scrambles the content and associates it with the ECM messages. The conditional access management module 42 moreover generates the EMM (entitlement management messages) messages and transmits the messages (arrow 50) to terminal 8 to ensure the management of the access rights purchased by the user. The access rights or the means for purchasing them (for example the tokens for impulse purchases of programmes) are managed in this manner and remotely entered by an operator 1 into a non-volatile storage device of security processor 46.

In the terminal device 8, the conditional access module 44 comprises a first module 52 for processing ECM and EMM messages in cooperation with the security processor 46. A second processing module 54 manages other complementary processing methods such as those concerning specific functions like the impulsive purchase of a pay-per-view (PPV) programme requiring a user agreement. When the conditions for accessing a content as defined in the ECM are satisfied, the conditional access module 44 supplies to the terminal 8 the control word (CW), thereby enabling the terminal to descramble the content and deliver the descrambled content to the user. The terminal 8 moreover has a user interface module 56.

The multiplication of services provided to the terminals, should they be they fixed or mobile, and the diversification of the contents provided as part of the services in addition to the lack of a single standard for protecting the contents make it difficult for multiple content-protection technologies to be implemented and interact in the same terminal.

Thus, the combination of separate content-protection technologies in the same receiving terminal conflicts with the different formats of the data processed by each of the technologies and also with the type of security-data processing specific to each of the technologies.

Generally, the diversity of content-protection technologies represents an obstacle to the convergence of services in terms of their clarity from the user's perspective.

The purpose of the invention is, on the one hand, to homogenize the protection of the contents in the same terminal supporting at least two distinct content-protection technologies, and, on the other hand, to enable one of the technologies to benefit from the security of the other, and more particularly to enable one DRM solution standardised at an increased security level to benefit from a CAS proprietary solution.

Another purpose of the invention is to make it easier for the user to implement the variations and the updates of the access control method used to strengthen the protection of the contents.

### DISCLOSURE OF THE INVENTION

The purposes of the invention are achieved by combining at least two content-protection technologies in the same terminal.

More specifically, this purpose is achieved by means of an access control using method a secret key K for controlling the access to a scrambled digital content distributed by an operator equipped with a content server and a rights server to at least one receiving terminal comprising a plurality of access-control modules, each access-control module using a specific technology for determining the secret key K.

This method comprises the following steps:
the content server transmits to terminal the scrambled content,
the rights server transmits to terminal the security data D(K) previously defined on the basis of the secret key K.

The method as per the invention moreover comprises the following steps:
prior to the broadcasting, the rights server incorporates into the security data D(K) a selection criterion permitting at least one of the access-control modules among the terminal's different access-control modules to decide to process the data D(K) alone to attempt to obtain the secret key K or to transmit at least a portion thereof to one of the terminal's other access-control modules.
When one of said access-control modules receives said security data D(K), said access-control module:
analyses the data D(K) to obtain said selection criterion and, based on its value,
terminates the processing of the data D(K) in order to obtain the secret key K,
or transmits a portion or all of said security data D(K) to at least one of the other access-control modules.

Each of the content-protection technologies involved can be either a conditional-access system (CAS), or a digital rights management system (DRM). The corresponding access-control module is thus a conditional-access module or a DRM agent, respectively. In both cases, the module has a method for determining the key K, said method comprising inter alia at least the evaluation of whether the receiving terminal has the right to descramble the received content or to decrypt a cryptogram K* of the secret key K, based on ECM and/or EMM messages in the case of a CAS or based on a DRM licence in the case of a DRM.

In a first embodiment of the invention, said selection criterion is deducible from the syntax of said security data D(K). An access-control module can deduce from, for example, the excessive or inadequate field length of security data D(K), like the cryptographic data field, that the field contains data it is not intended to process.

In a second embodiment of the invention, said selection criterion is a bit or a group of bits among the security data D(K). For example, a field of that data is dedicated to an identifier of the technology for determining the key K to be applied.

Preferably, the scrambled content and the security data are transmitted to the terminal respectively by the content server and by the rights server simultaneously or asynchronously.

In a first embodiment of the invention, the security data D(K) comprise at least one ECM and/or at least one DRM licence.

In a variant of this embodiment, the ECM message is encapsulated in the DRM licence.

In another variant, said set of security-data D(K) moreover comprises an EMM message intended to update or register a key or an access right into a non-volatile storage device of said terminal.

According to another feature of the invention, said security data D(K) are entirely or partially encrypted.

The invention therefore makes it possible to mitigate the heterogeneity of content-protection systems used resulting from the diversity of the content-providing services used.

The invention furthermore enables the operator to effect the variations and evolutions of the content-protection system used in order to strengthen the content protection.

The method according to the invention is carried out by an access-control system to a scrambled digital content provided by an operator to a receiving terminal comprising a plurality of separate access-control modules, each access-control module implementing a specific technology for determining the secret key K, said access-control system comprising:
a content server comprising means for scrambling the content by a secret key K,
a rights server comprising means for calculating the security data D(K) on the basis of the secret key K.

The system according to the invention is characterised in that:
the rights server furthermore comprises means for incorporating a selection criterion into the security data D(K), said selection criterion permitting at least one of the access-control modules among the terminal's many access-control modules to determine whether to process the data D(K) alone in order to attempt to obtain the secret key K or to transmit at least a portion of the data to one of the terminal's other access-control modules.

The terminal receiving the content scrambled by secret key K provided by the operator comprises a plurality of separate access-control modules, each implementing a specific technology for determining said secret key K. The terminal moreover receives from said operator the security data D(K) comprising a criterion for selecting a control module from among the plurality of the terminal's access-control modules.

The terminal is characterised in that one of said access-control modules comprises means for analysing said selection criterion so as to decide whether to process the data D(K) alone in order to attempt to obtain the secret key K or to transmit at least a portion of the data to one of the terminal's other access-control modules.

In a particular embodiment, the terminal according to the invention comprises a smart card as a security processor in addition to two access-control modules, wherein the first module is a DRM (digital rights management) agent and the second module is a conditional-access module.

### BRIEF DESCRIPTION OF THE DRAWINGS

Further features and advantages of the invention will become apparent from the following description, using non-limiting examples, taken in combination with the appended drawings, wherein:

the previously-described FIG. 1 schematically illustrates a content-distribution system wherein a DRM-type content-protection technology is implemented,

the previously-described FIG. 2 is a schematic representation of a content object and a rights object which respectively designate a digital content and a licence associated with that content in the context of a DRM-type content-protection technology,

the previously-described FIG. 3 schematically illustrates a classic architecture of a content-distribution system wherein a CAS-type content-protection technology is implemented,

FIG. 4 represents a general block diagram of a particular example of the system according to the invention,

FIG. 5 schematically illustrates a particular example of the implementation of the method according to the invention in the system depicted in FIG. 4,

FIG. 6 is a flowchart illustrating the steps of the method according to the invention.

### DETAILED DESCRIPTION OF PARTICULAR EMBODIMENTS

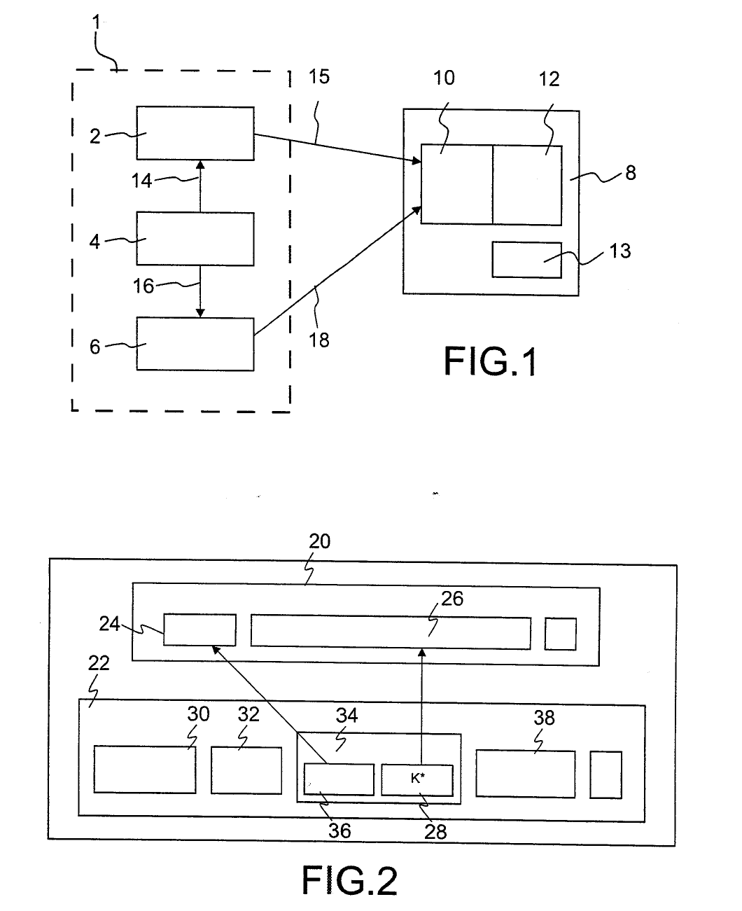

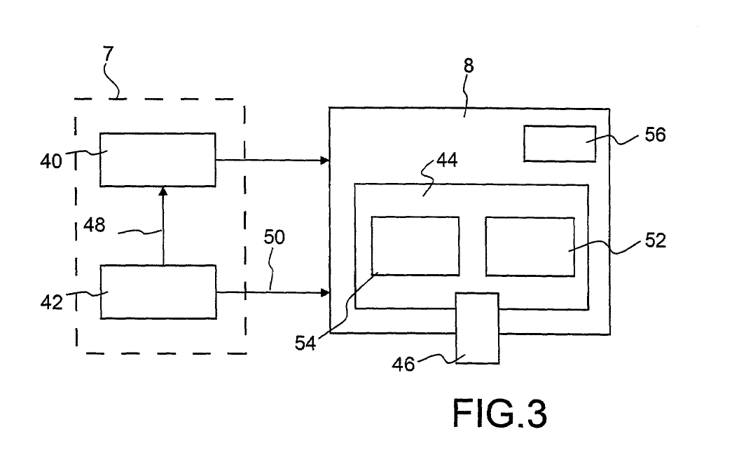

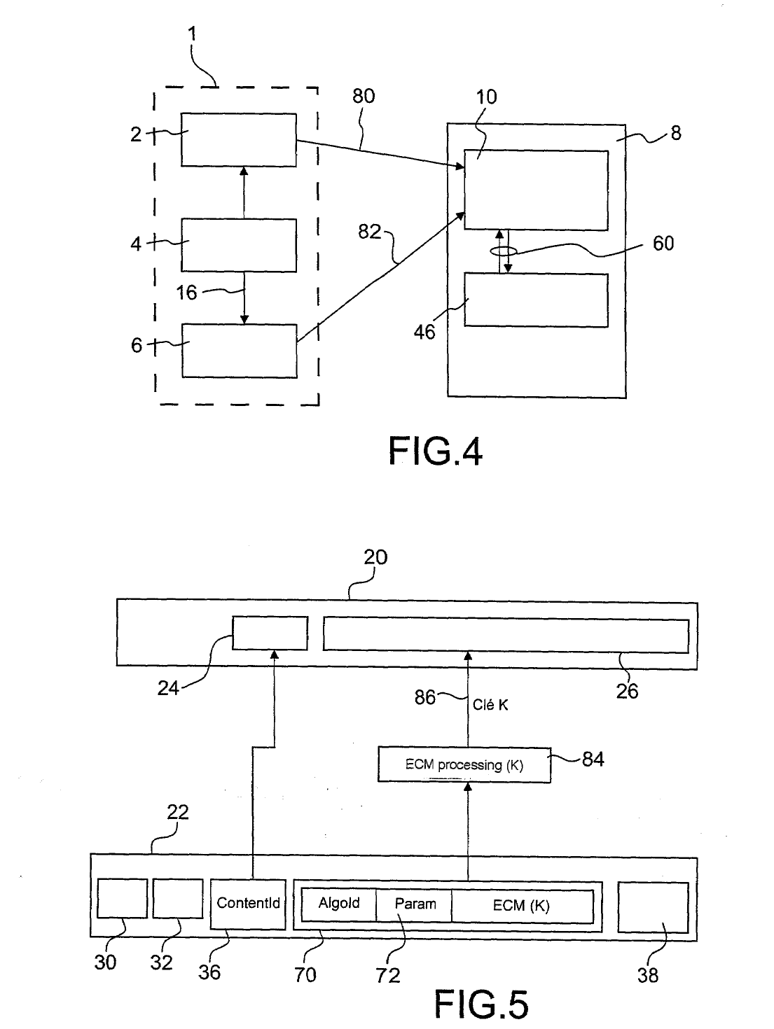

The invention will be described, in reference to FIGS. 4, 5, and 6, in an example of the embodiment wherein a digital content representing the data or the audiovisual programs scrambled by a secret key K is provided by an operator 1 at a receiving terminal 8 supporting a protection technology based on the OMA DRA (Open Mobile Alliance, Digital Rights Management) standard and a protection technology based on a conditional access system (CAS).

It is to be noted that the invention is not limited to the above context and is applicable regardless of the content-protection technologies used.

Throughout the following description, identical references designate the elements common the figures of the prior art and to the figures illustrating the invention.

In reference to FIG. 4, the operator 1 has a content server 2 that is associated with a module 4 for formatting said contents and with a licences server 6.

The terminal 8 comprises two access-control modules, the first being a DRM agent 10 that is in conformity with the OMA DRM standard and communicates through an interface 60 with the second access-control module which is a conditional-access module 46 that comprises a security processor, such as a smart card, and contains the access titles to the scrambled content. Said security processor can be implemented in software format without departing from the scope of the invention.

Prior to providing the content to terminal 8, the formatting module 4 generates the data specific to the DRM technology, as FIG. 5 schematically illustrates, comprising a content object 20 and a rights object 22 typically called a licence.

The content object 20 comprises a content identifier 24 and a document 26 comprising the data (video, audio etc.) encryptable by key K.

The rights object 22 constitutes the security data D(K) and comprises inter alia the identifier 30 of the right, an attribute 32 (stateful/stateless) indicating whether the right will change during its use, the identifier 36 of the content associated with that licence, a description 38 of permissions and constraints upon the use of the content, and the cryptographic data 70 containing at least the key K.

In the example of the described embodiment, the cryptographic data 70 comprise an ECM comprising the cryptogram K* of the key K and at least one access condition, an AlgoId identifier of the algorithm for the security processor 46 to process the ECM, and the Param 72 parameters necessary for executing the algorithm designated by the AlgoId identifier.

The cryptographic data 70 moreover may comprise an EMM message that the security processor 46 can interpret, thus making it possible, for example, to update or register a key or an access right into the terminal's non-volatile storage device.

During operation and prior to broadcasting the content, the licence server incorporates into the security data D(K) a selection criterion permitting at least one of the access-control modules (10, 46) among the terminal's (8) different access-control modules to decide to process the data D(K) alone in order to attempt to obtain the secret key K or to transmit at least a portion of the data to one of the terminal's other access-control modules.

Said selection criterion is either deducible from the syntax of said security data D(K) or is a bit or a group of bits among the security data D(K).

In the described embodiment, said selection criterion is the value of the AlgoId identifier of the ECM processing algorithm.

The content server 2 transmits the scrambled content to terminal 8 (arrow 80) and the licence server 6 transmits the DRM licence described in FIG. 5 to terminal 8 (arrow 82).

The transmissions may occur simultaneously or asynchronously.

At the terminal level, the DRM agent 10 processes the structure of the security data 70 in order to decrypt the scrambled content.

On the basis of the particular value of the AlgoId identifier, the DRM agent detects that the licence does not contain the cryptogram of the key K as is customary but rather contains a data set, typically an ECM message, intended for the CAS technology with which it cooperates. The DRM agent thus executes the algorithm designated by the AlgoId identifier, with the Param 72 parameters, to extract the ECM from the DRM licence. Once the ECM has been extracted, the DRM agent 10 transmits it, via interface 60, to the security processor 46. The security processor processes the ECM in a manner known per se (block 84, FIG. 5), that is to say it verifies that the access conditions contained in the ECM are satisfied and it decrypts the cryptogram K* if the access conditions are satisfied by at least one access title, subsequent to which it returns (arrow 86, FIG. 5) the key K extracted from the ECM to the DRM agent 10. The DRM agent then uses this key to descramble the content.

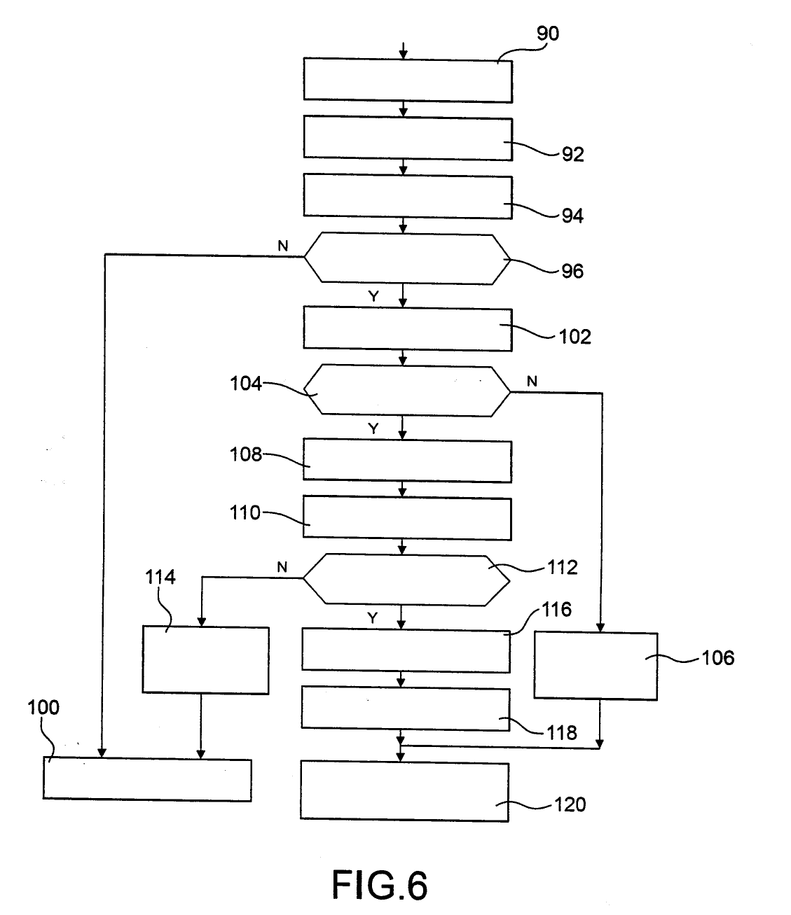

The essential steps of the method according to the invention shall now be described in reference to FIG. 6.

At step 90, the terminal receives the scrambled content and the DRM licence associated with that content.

It should be noted that obtaining the protected content and obtaining the licence may occur in any order.

At step 92, the user requests access to the content. At step 94, the DRM agent determines the licence associated with the content, possibly with additional dialogue with the user in order to select a licence among many possibilities.

At step 96, the DRM agent 10 verifies the syntax, integrity and authenticity of the DRM licence as well as the authorisations and constraints 38 upon access to the content.

If there is an anomaly in the licence or if the authorisations and constraints 38 are not satisfied, then the DRM agent 10 refuses access to the content at step 100.

If the licence is correct and if the authorisations and constraints 38 are satisfied, the DRM agent 10 extracts the data relating to the key K for the decryption of the content (step 102).

At step 104, the DRM agent 10 analyses the AlgoId algorithm identifier and specifically detects if the data relating to the key K extracted during step 102 are supplied to the CAS system.

If this is not the case, the cryptogram K* is decrypted by the DRM agent 10 in step 106 according to the customary method typical to DRM technology.

If this is the case, the data extracted in step 102 constitute an ECM and at step 108, the DRM agent 10 transmits that ECM to the conditional-access module. The security processor 46 associated with the conditional-access module processes the received ECM in step 110 and verifies in step 112 if the ECM message is correct and if the access condition contained in the ECM is satisfied by at least one access title present in the security processor 46.

If this is not the case, the security processor 46 sends an error message to the DRM agent 10 in step 114. Subsequently, the DRM agent refuses access to the content in step 100.

If this is the case, the security processor 46 decrypts the cryptogram K* present in the ECM during step 116, and the conditional-access module transmits the key K to the DRM agent via interface 60 in step 118.

In step 120, the DRM agent 10 descrambles the content by means of key K.

1. A method for controlling access to a digital content scrambled by a secret key K and distributed by an operator, said operator being equipped with a content server and a rights server, to at least one receiving terminal comprising a plurality of access-control modules, each access-control module implementing a specific technology for determining the secret key K,
in which:
the content server transmits the scrambled content to the terminal,
the rights server transmits to the terminal the security data D(K) previously defined according to the secret key K,
a method characterised in that:
prior to broadcasting, the licence server incorporates into the security data D(K) a selection criterion permitting at least one of the access-control modules among the terminal's different access-control modules to decide to process the data D(K) alone in order to attempt to obtain the secret key K or to transmit at least a portion of the data to one of the terminal's other access-control modules.
when one of said access-control modules receives said security data D(K), said access-control module:
analyses the data D(K) to obtain said selection criterion and, based on its value,
terminates the data D(K) processing in order to obtain the secret key K,
or transmits a portion or the totality of said security data D(K) to at least one of the other access-control modules.

2. A method according to claim 1 in which said selection criterion can be deduced from the syntax of said security data D(K).

3. A method according to claim 1 in which said selection criterion is a bit or a group of bits among the security data D(K).

4. A method according to claim 1 in which the scrambled content and the security data are respectively transmitted to the terminal by the content server and by the rights server simultaneously or asynchronously.

5. A method according to claim 1 in which the security data D(K) comprise at least one ECM and/or at least one DRM licence.

6. A method according to claim 5 in which the ECM message is encapsulated in the DRM licence.

7. A method according to claim 1 in which said security data set D(K) moreover comprises an EMM message intended to update or register a key or an access right into a non-volatile storage device of said terminal.

8. A method according to claim 1 in which the security data D(K) are entirely or partially encrypted.

9. System for controlling access to a scrambled digital content supplied by an operator to a receiving terminal having a plurality of separate access-control modules, each access-control module implementing a specific technology for determining the secret key K, said system comprising:
a content server having means to scramble the content by means of a secret key K,
a rights server having means to calculate the security data D(K) according to the secret key K, said system characterised in that:
the rights server comprises moreover means for incorporating into the security data D(K) a selection criterion permitting at least one of the access-control modules among the different access-control modules of the terminal to decide to process the data D(K) alone in order to attempt to obtain the secret key K or to transmit at least a portion of the data to one of the terminal's other access-control modules.

10. Receiving terminal for receiving from an operator a scrambled content by means of a secret key K, said terminal having a plurality of separate access-control modules, each access-control module implementing a specific technology for determining said secret key K, and said terminal furthermore receiving from said operator security data D(K) comprising a selection criterion for selecting one access-control module from among the plurality of the terminal's access-control modules, characterised in that:
one of said access-control modules comprises means for analysing said selection criterion so as to determine whether to process the data D(K) alone in order to attempt to obtain the secret key K or to transmit at least a portion of the data to one of the terminal's other access-control modules.

11. A terminal according to claim 10, said terminal comprising two access-control modules, wherein the first module is a DRM (digital rights management) agent and the second module is a conditional-access module.

12. A terminal according to claim 11 comprising a smart card as a security processor.

13. A computer program recorded on a medium and, when run by a computer, intended to implement a method for controlling access to a digital content scrambled by a secret key K and distributed by an operator, said operator being equipped with a content server and a rights server, to at least one receiving terminal comprising a plurality of access-control modules, each access-control module implementing a specific technology for determining the secret key K,
in which:
the content server transmits the scrambled content to the terminal,
the rights server transmits to the terminal the security data D(K) previously defined according to the secret key K,
prior to broadcasting, the licence server incorporates into the security data D(K) a selection criterion permitting at least one of the access-control modules among the terminal's different access-control modules to decide to process the data D(K) alone in order to attempt to obtain the secret key K or to transmit at least a portion of the data to one of the terminal's other access-control modules.
when one of said access-control modules receives said security data D(K), said access-control module:
analyses the data D(K) to obtain said selection criterion and, based on its value,
terminates the data D(K) processing in order to obtain the secret key K,
or transmits a portion or the totality of said security data D(K) to at least one of the other access-control modules;
practiced in a receiving terminal for receiving from an operator a scrambled content by means of a secret key K, said terminal having a plurality of separate access-control modules, each access-control module implementing a specific technology for determining said secret key K, and said terminal furthermore receiving from said operator security data D(K) comprising a selection criterion for selecting one access-control module from among the plurality of the terminal's access-control modules.
